(19) United States
(12) Patent Application Publication
(10) Pub. No.: US 2013/0028692 A1
(43) Pub. Date: Jan. 31, 2013

(54) AUTOMATIC POSITIONING DEVICE

(71) Applicants: CHIH-PEN LIN, Shin-dian (TW); YU-HSIANG LEE, Shin-dian (TW); WEI-BEN CHEN, Shin-dian (TW)

(72) Inventors: CHIH-PEN LIN, Shin-dian (TW); YU-HSIANG LEE, Shin-dian (TW); WEI-BEN CHEN, Shin-dian (TW)

(73) Assignee: FIH (HONG KONG) LIMITED, Kowloon (HK)

(21) Appl. No.: 13/328,026

(22) Filed: Dec. 16, 2011

(30) Foreign Application Priority Data
Jul. 26, 2011 (TW) 100126278

(51) Int. Cl. B25J 11/00

(52) U.S. Cl. 414/222.13; 414/589

(57) ABSTRACT

An automatic positioning device includes a holder, a first motor, a securing block, a second motor, and a connecting rod. The first motor is mounted on the holder and horizontally slides relative to the holder. The securing block is fixed with the first motor. The second motor is mounted on the securing block and vertically slides relative to the securing block. The connecting rod is connected with the second motor. The first motor drives the connecting rod moving horizontally and the second motor drives the connecting rod moving vertically.

### BACKGROUND

1. Technical Field

The present disclosure relates to an automatic positioning device.

2. Description of Related Art

To improve glossiness of aluminum products, strong acid, such as phosphoric acid, nitric acid, or sulfuric acid may be used as polishing solutions to polish the aluminum products under a high temperature. After the polishing, the aluminum products should be quickly removed from the polishing solution and be put into water bath to rinse. If the aluminum products are exposed to the air for more than 10 seconds, the residue strong acid attached on the aluminum products may erode the aluminum products and decrease the glossiness of the aluminum products. The operation of the aluminum products are commonly performed manually by operators, and are prone to improper exposure time.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings like reference numerals designate corresponding parts throughout the several views.

FIG. 1 is an exploded view of an exemplary embodiment of an automatic positioning device.

FIG. 2 is an assembly view of an exemplary embodiment of the automatic positioning device shown in FIG. 1.

### DETAILED DESCRIPTION

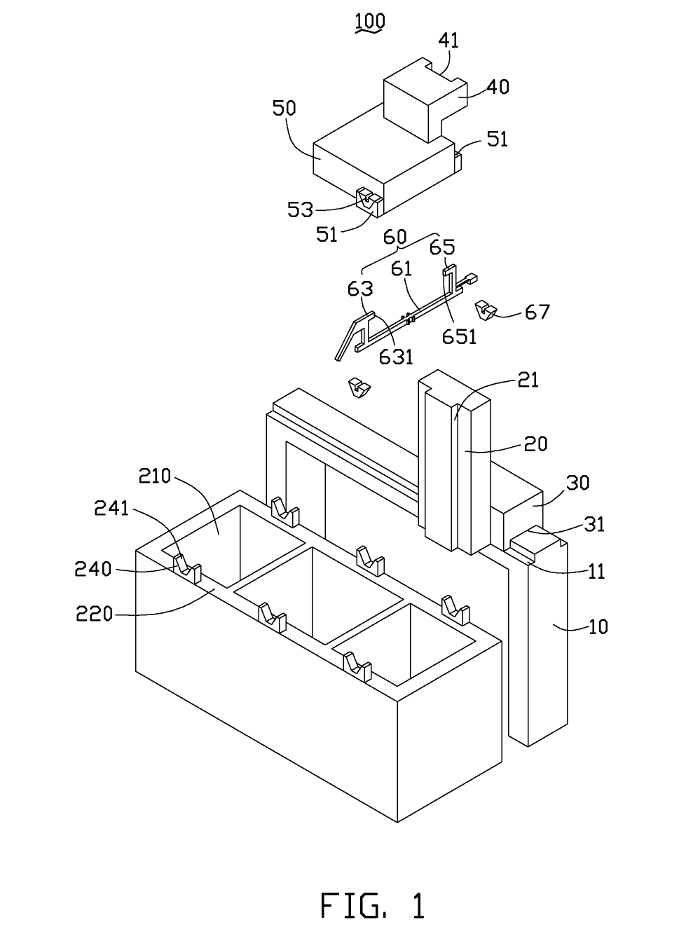

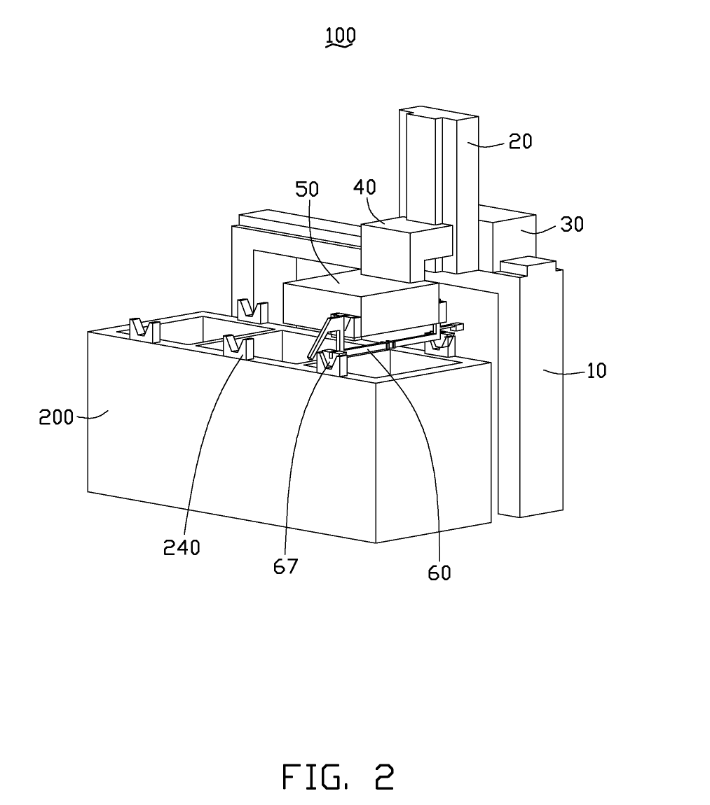

FIG. 1 and FIG. 2 show an automatic positioning device 100 used to transfer workpieces among different workstations.

Referring to FIG. 1, the automatic positioning device 100 includes a holder 10, a securing block 20, a first motor 30, a second motor 40, a connecting block 50, and a connecting rod 60.

The holder 10 defines with a first sliding rail 11 at the top surface. The first motor 30 defines with a first sliding slot 31 mating with the sliding rail 11. The sliding rail 11 engages in the sliding slot 31, making the first motor 30 horizontally slidable relative to the holder 10.

The securing block 20 is defined with a second sliding rail 21 on its sidewall opposite to the first motor 30. The second motor 40 is defined with a second sliding slot 41 mating with the sliding rail 21. The sliding rail 21 engages in the sliding slot 41, making the second motor 40 vertically slidable relative to the securing block 20. The securing block 20 is fixed with the first motor 30 by screws or other conventional fasteners. The first motor 30 and the second motor 40 are respectively mounted on the opposite two side walls of the securing block 20 (best seen in FIG. 2).

The second motor 40 is connected with the connecting block 50 by the bottom surface of the second motor 40 fixing to the connecting block 50 by screws or other conventional fasteners.

The connecting block 50 is fixed with two latching blocks 51 on its opposite two side walls by screws or other conventional fasteners. Each latching block 51 is defined with a first latching slot 53 on its top surface.

The connecting rod 60 includes a rod portion 61, a first connecting portion 63 and a second connecting portion 65 vertically protrude from the top surface of the rod portion 61, near the two ends of the rod portion 61. The first connecting portion 63 defines with a first latching portion 631 projecting from one side and towards the second connecting portion 65. The second connecting portion 65 defines with a second latching portion 651 projecting from one side and towards the first connecting portion 63. The first latching portion 631 and the second latching portion 651 are respectively latched in the two first latching slots 53 of the latching block 51 to make the connecting rod 60 securely connected with the connecting block 50.

Two latching blocks 67 are provided and latched with the rod portion 61 on the bottom surface of the rod portion 61 and near the two ends of the rod portion 61. The rod portion 61 may be hung with racks loaded with workpieces.

Referring to FIG. 2, in this embodiment, a reaction bath 200 is provided. The automatic positioning device 100 is located beside one side of the reaction bath 200 and the connecting rod 60 is located above the reaction bath 200. The reaction bath 200 includes three adjacent solution baths 210. The three solution baths 210 may be pre-dipping bath, chemical polishing bath, and water rinsing bath.

Each solution bath 210 includes two opposite side walls 220. Each side wall 220 defines a receiving block 240. Each receiving block 240 defines a second latching slot 241 mating with each latching block 67. The two latching blocks 67 are latched in the two second latching slots 241, making the connecting rod 60 secured in the reaction bath 200.

During operation of the automatic positioning device 100, a rack loaded with workpieces (not shown) are hung on the rod portion 61 of the connecting rod 60. The workpieces may be aluminum products, copper products, titanium products, stainless steel products, or magnesium and magnesium alloy products. The first motor 30 is turned on to horizontally move the connecting rod 60. When the two latching blocks 67 arrive at the two second latching slots 241, the first motor 30 is turned off. The second motor 40 is turned on to lowered the connecting rod 60 and the racks until the two latching blocks 67 are latched in the two second latching slots 241. At this time, the second motor 40 is turned off, and the workpieces all dip in the solution bath 210. For removing the workpieces from one solution bath to another solution bath, the second motor 40 is turned on to lift the connecting rod 60 away from the solution bath. The first motor 30 is turned on to horizontally move the connecting rod 60, simultaneously the second motor 40 drives the connecting rod 60 and the racks to move down and make the workpieces dip in another solution bath. As such, the workpieces are rapidly removed from one solution bath to another solution bath.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An automatic positioning device, comprising:
a holder;
a first motor mounted on the holder and horizontally slidable relative to the holder;
a securing block fixed with the first motor;
a second motor mounted on the securing block and vertically slidable relative to the securing block; and
a connecting rod connected with the second motor, the first motor driving the connecting rod to horizontally move, and the second motor driving the connecting rod to vertically move.

2. The automatic positioning device as claimed in claim 1, wherein the holder is defined with a first sliding rail in the top surface of the holder, the first motor is defined with a first sliding slot mating with the first sliding rail, the first sliding rail engages in the first sliding slot to make the first motor horizontally slide relative to the holder.

3. The automatic positioning device as claimed in claim 1, wherein the securing block is defined with a second sliding rail on the side wall of the securing block opposite to the first motor, the second motor is defined with a second sliding slot mating with the second sliding rail, the second sliding rail engages in the second sliding slot to make the second motor vertically slide relative to the securing block.

4. The automatic positioning device as claimed in claim 1, wherein the securing block is fixed with the first motor.

5. The automatic positioning device as claimed in claim 1, wherein the first motor and the second motor are respectively mounted on the opposite two side walls of the securing block.

6. The automatic positioning device as claimed in claim 1, wherein the connecting rod includes a rod portion, a first connecting portion and a second connecting portion respectively vertically formed on the top surface of the rod portion and near the two ends of the rod portion.

7. The automatic positioning device as claimed in claim 6, wherein the second motor is connected with a connecting block by the bottom surface of the second motor fixing to the connecting block, the connecting block is fixed with two latching blocks on the opposite two side walls of the connecting block, each latching block is defined with a first latching slot on the top surface of the latching block; the first connecting portion defines with a first latching portion projecting from one side of the first connecting portion and towards the second connecting portion, the second connecting portion defines with a second latching portion projecting from one side of the second connecting portion and towards the first connecting portion, the first latching portion and the second latching portion are respectively latched in the two first latching slots of the latching block to make the connecting rod connected with the connecting block and the second motor.

8. The automatic positioning device as claimed in claim 7, wherein the device is located beside one side of a reaction bath and the connecting rod is located above the reaction bath, the reaction bath comprises several adjacent solution baths.

9. The automatic positioning device as claimed in claim 8, two latching blocks are respectively latched in the rod portion on the bottom surface of the rod portion and near the two ends of the rod portion; each solution bath includes two opposite side walls, each side wall is defined with a receiving block, each receiving block forms a second latching slot which mates with each latching block, the two latching blocks are respectively latched in the two second latching slots to make the connecting rod be secured in on the reaction bath.

10. An automatic positioning device, comprising:
a holder;
a first motor assembled to the holder and horizontally slidable relative to the holder;
a securing block attached to the first motor and horizontally slidable relative to the holder;
a second motor assembled to the securing block and vertically slidable relative to the securing block; and
a connecting rod connected with the second motor, the first motor driving the connecting rod to horizontally move, and the second motor driving the connecting rod to vertically move.

11. The automatic positioning device as claimed in claim 10, wherein the holder is defined with a first sliding rail in the top surface of the holder, the first motor is defined with a first sliding slot mating with the first sliding rail, the first sliding rail engages in the first sliding slot to make the first motor horizontally slide relative to the holder.

12. The automatic positioning device as claimed in claim 10, wherein the securing block is defined with a second sliding rail on the side wall of the securing block opposite to the first motor, the second motor is defined with a second sliding slot mating with the second sliding rail, the second sliding rail engages in the second sliding slot to make the second motor vertically slide relative to the securing block.

13. The automatic positioning device as claimed in claim 10, wherein the securing block is fixed with the first motor.

14. The automatic positioning device as claimed in claim 10, wherein the first motor and the second motor are respectively attached to the opposite two side walls of the securing block.

15. The automatic positioning device as claimed in claim 10, wherein the connecting rod includes a rod portion, a first connecting portion and a second connecting portion respectively vertically formed on the top surface of the rod portion and near the two ends of the rod portion.

16. The automatic positioning device as claimed in claim 15, wherein the second motor is connected with a connecting block by the bottom surface of the second motor fixing to the connecting block, the connecting block is fixed with two latching blocks on the opposite two side walls of the connecting block, each latching block is defined with a first latching slot on the top surface of the latching block; the first connecting portion defines with a first latching portion projecting from one side of the first connecting portion and towards the second connecting portion, the second connecting portion defines with a second latching portion projecting from one side of the second connecting portion and towards the first connecting portion, the first latching portion and the second latching portion are respectively latched in the two first latching slots of the latching block to make the connecting rod connected with the connecting block and the second motor.

17. The automatic positioning device as claimed in claim 16, wherein the device is located beside one side of a reaction bath and the connecting rod is located above the reaction bath, the reaction bath comprises several adjacent solution baths.

18. The automatic positioning device as claimed in claim 17, two latching blocks are respectively latched in the rod portion on the bottom surface of the rod portion and near the two ends of the rod portion; each solution bath includes two opposite side walls, each side wall is defined with a receiving block, each receiving block forms a second latching slot which mates with each latching block, the two latching blocks are respectively latched in the two second latching slots to make the connecting rod be secured in on the reaction bath.
